(19) United States
(12) Patent Application Publication
(10) Pub. No.: US 2002/0049648 A1
(43) Pub. Date: Apr. 25, 2002

(54) Production information managing method of product, control center therefor and production information managing system of product

(75) Inventors: Teruo Inoue, Tokyo (JP); Masayuki Sarumaru, Tokyo (JP); Akira Matsuda, Kurobe-Shi (JP); Hirotoshi Suzuki, Shizuoka-Ken (JP)

Correspondence Address: Finnegan, Henderson, Farabow, Garrett & Dunner, L.L.P., 1300 I Street, N.W., Washington, DC, 20005-3315, US

(73) Assignee: YKK Corporation

(21) Appl. No.: 09/983,078

(22) Filed: Oct. 23, 2001

(30) Foreign Application Priority Data
Oct. 23, 2000 (JP) 2000-322633

(51) Int. Cl. G06F 17/60

(52) U.S. Cl. 705/26

(57) ABSTRACT

In order to efficiently utilize production information on a product among an orderer, a primary order-receiver and a secondary order-receiver to efficiently produce a product, an apparel maker, a vendor, a component factory of accessory of apparel goods etc., an assembly factory and a control center (6) are communicatably connected, the control center (6) displaying a primary prediction information including information on outline total production amount and final delivery date on a web page, commanding a preceding production of accessory component used for the apparel goods etc., displaying a final prediction information including information on the total production amount and the final delivery date with higher accuracy on the web page, designating the assembly factory, commanding transportation of the precedingly produced component and assembly of the accessory to the component factory and the assembly factory and urging to order the accessory to the vendor, the assembly factory assembling the accessory to deliver to the vendor, the vendor assembling the accessory to the apparel goods to deliver to the apparel maker.

### BACKGROUND OF THE INVENTION

1. Field of the Invention

The present invention relates to a production information managing method, a control center therefor and a production information managing system of a product. More specifically, it relates to production information management of a product in apparel field and field of building material for housing etc., where taste of consumer has to be rapidly reflected.

2. Description of Related Art

Various products are circulating in market. Among the products, there are apparel goods such as clothes, bags and shoes (which are referred to as “apparel goods etc.” hereinafter) in the apparel field.

In general, the production of the apparel goods etc. is planned and started by apparel maker one season before the apparel goods etc. is actually circulated in the market.

Production and information flow of conventional production of the apparel goods etc. will be described below with reference to FIGS. 6 and 7.

FIG. 6 is a flowchart showing a conventional production flow of the apparel goods etc., and FIG. 7 is a time chart showing the flowchart of production of the apparel goods etc. separately for actions of each of the apparel maker (orderer), a vendor (primary order-receiver) and an accessory factory (secondary order-receiver). FIGS. 6 and 7 will be simultaneously referred to in the following description.

As shown in FIGS. 6 and 7, the production of the apparel goods etc. is started one season prior to actual circulation of the apparel goods etc. by planning and designing by the apparel maker (step S400 (S6)). After completing outline concept and design, the apparel maker orders the vendor to manufacture a trial piece and submit an estimate (FIG. 7).

After the sample piece is made, the sample is reviewed and further change in design and specification is conducted by the apparel maker for several times, thereby determining final design and specification (step S410 (FIG. 6)).

After the final design and specification are determined, the apparel maker chooses vendor (a plurality of vendors, in some cases), and orders to manufacture the apparel goods etc. to the vendor (step S420 (FIG. 6), FIG. 7).

After receiving the order of production of the apparel goods etc. from the apparel maker, the vendor orders accessories (fastener, for instance) used for apparel goods etc. to the accessory factory (step S430 (FIG. 6), FIG. 7). Incidentally, the accessory factory is freely chosen by the vendor.

The factory having received the production order of the accessories starts manufacturing component (slider, tape of the fastener, for instance), assembles the completed component into the accessories (step S440 (FIG. 6)), and deliver the completed accessories to the vendor (FIG. 7).

On the other hand, the vendor simultaneously manufactures the apparel goods etc. (sewing garment portion etc.) while the accessory factory manufactures the accessory and, when the accessories are delivered from the accessory factory, assembles the accessories to the apparel goods etc. (step S440 (FIG. 6), FIG. 7).

The completed apparel goods etc. is delivered from the vendor to the apparel maker.

As described above, in conventional production of apparel goods etc., the design and specification of the apparel goods etc. are continuously changed until sewing of the apparel goods etc. is ordered to the vendor, and production of the accessories is started only after the apparel maker orders the sewing of the apparel goods etc. to the vendor.

It ordinarily takes considerable time for producing accessories, and the vendor often has to wait for the accessories to be completed.

Accordingly, the assembling process of the accessories to the apparel goods etc. is delayed, so that the entire delivery time of the apparel goods etc. is lengthened.

On the other hand, the accessories may be precedingly produced. However, since the design and specification of the apparel goods are repeatedly changed until the order is placed to the vendor, it is impossible to start production of accessories at an early stage.

Further, since the vendor is freely chosen by the apparel maker for every season, the location of the vendor cannot be determined and transport means cannot be secured at a suitable time for delivering the product from the accessory factory to the vendor. The production time of the vendor can be lengthened on account of trouble for arranging the transport means.

Accordingly, a production information managing method and production managing system of apparel goods etc. capable of achieving highly efficient production of the apparel goods etc. are strongly desired, where information on the apparel goods etc. to be produced by the apparel maker is distributed to vendors, component factories and assembly factories of accessories of the apparel goods through the Internet, the respective organization can be efficiently cooperated and the production is controlled in an integrated manner by a computer in a so-called “control center” in a manner where the control center, the component factory and the assembly factory work as a single “virtual factory”.

Such problems and demand also are applied to an architectural field such as housing (i.e. building material field used in an architecture) where the design finalization is likely to be delayed by being effected by the taste of consumers. Window sash, door etc. can be cited as products in the building material field.

An object of the present invention is to provide a production information managing method, a control center therefor and a production information managing system capable of achieving efficient production of products by efficiently sharing information on products to be produced in the next season by the orderer among the orderer, the primary order-receiver and the secondary order-receiver.

### SUMMARY OF THE INVENTION

A production information managing method according to the present invention includes the step of: comminicatably connecting an orderer of a product, a primary order-receiver producing the product based on an order from the orderer, a secondary order-receiver producing a product element constituting the product based on a order from the primary orderer, and a control center for managing a production information of the product through a network, where the control center sets a primary prediction information by obtaining a total production amount information and a final delivery date information of the product to be produced from the orderer, commands a preceding production of a predetermined component constituting the product element to a predetermined secondary order-receiver based on the primary prediction information, sets a final prediction information by obtaining from the orderer another total production amount information and another final delivery date information with higher accuracy than the primary prediction information and information on the primary order-receiver having received the order of the product, and formally orders the product element through the primary order-receiver or directly to the secondary order-receiver having conducted the preceding production.

According to the above arrangement, for instance, information on the next-season product of the orderer is continuously collected at the planning stage and the total production amount and the final delivery date of the product are presented to the primary order-receiver or the secondary order-receiver as the primary prediction information when the outline design and specification of the product are determined, while starting the preceding production to an appropriate secondary order-receiver for the component capable of preceding production.

When the design and specification of the product are settled and order is placed to the primary order-receiver, the final design and specification of the product, the primary order-receiver, the total production amount and the final delivery date of the product are disclosed to the related party and assembly of the product element is simultaneously commanded to the secondary order-receiver.

Accordingly, the component is substantially completed by the secondary order-receiver when the primary order-receiver receives the order, so that the component can be immediately delivered to the primary order-receiver. On the other hand, for the primary order-receiver, the product element of the required specification can be obtained from the secondary order-receiver at an extremely short time period. Accordingly, production time of the product by the primary order-receiver can be greatly reduced, thereby greatly reducing entire delivery time of the product to the orderer.

In the production information managing method according to the present invention, the control center may preferably select the predetermined secondary order-receiver with reference to pre-stored data of a production capacity and a load condition of the secondary order-receiver, and command the preceding production and production of the product element to the secondary order-receiver so as to be in time for the final delivery date of the product.

By the selection process of the secondary order-receiver, the entire production efficiency can be further enhanced.

Specifically, by numerically managing the production capacity and load condition of the secondary order-receiver by the control center, the work load required for production can be converted into a certain value and distributed to the secondary order-receiver when the specification of the product element is determined. Accordingly, concentration of the work to a specific secondary order-receiver can be prevented, thereby utilizing the entire production capacity with the most efficient condition to produce the apparel goods etc.

In the production information managing method according the present invention, the control center may preferably support to set up a plan including action item to be taken by the primary order-receiver and the secondary order-receiver and specific date thereof so as to be in time for the final delivery date of the product, and manage a schedule necessary for the primary order-receiver and the secondary order-receiver.

On account of the schedule management, operation delay of the primary order-receiver and the secondary order-receiver can be prevented, thereby further enhancing the production efficiency as a whole.

In the production information managing method according to the present invention, the control center may preferably supply information on the predetermined secondary order-receiver producing the product element used for the product and information on production completion time of the product element and notify a final order time of the product element capable of being in time for the final delivery date of the product.

By securely supplying the information on the preceding production by the secondary order-receiver to the primary order-receiver, the above-described schedule management can be efficiently functioned.

In the production information managing method according to the present invention, the control center may preferably command the primary order-receiver to order the product element to the secondary order-receiver having conducted the preceding production based on the final prediction information, and command the secondary order-receiver to produce the product element from the precedingly produced components in order to deliver the product element in time for the time required for the primary order-receiver.

On account of the above schedule management, cooperative work from the orderer to the primary order-receiver or the secondary order-receiver can go smooth, thereby further enhancing production efficiency as a whole.

As described above, in the production information managing method of product, the information on the product, the primary order-receiver and the secondary order-receiver can be concentrated and the production schedule of the primary order-receiver and the secondary order-receiver can be planned and managed. Accordingly, the respective party engaged in production of the product can conduct production activity in a mutually organized manner, thereby achieving reasonable and highly efficient production of products.

For instance, the schedule of the primary order-receiver and the secondary order-receiver is managed by, for instance, urging final order date of the product element to the primary order-receiver, so that appropriate countermeasure can be taken to rapidly restore the production delay by utilizing production capacity.

In the production information managing method according to the present invention, the secondary order-receiver may preferably be a component factory for producing the component and/or an assembly factory for assembling the product element from the component, and the control center may preferably command preceding production of the predetermined component to the predetermined component factory and/or the assembly factory when the primary prediction information is set, command assembly of the precedingly produced component into the product element to the component factory and/or the assembly factory when the final prediction information is set and transmit information on the product element and the predetermined component factory and/or the assembly factory to the primary order-receiver to command to place an order of the product element to the predetermined component factory and/or the assembly factory.

More specifically, in the production information managing method according to the present invention, the secondary order-receiver may preferably be a component factory for producing the component and an assembly factory for assembling the product element from the component, and the control center commands preceding production of the predetermined component to the predetermined component factory when the primary prediction information is set, command to the component factory to transport the precedingly produced component to the predetermined assembly factory and command to the assembly factory to assemble the precedingly produced component into the product element when the final prediction information is set, and transmit information on the product element and the predetermined assembly factory to the primary order-receiver to command to place an order of the product element to the predetermined assembly factory.

In apparel industry and building industry, the secondary order-receiver producing the production element may be arranged in double-hierarchy of component factory and assembly factory or more. The present invention can be applied in such case, where the preceding production may preferably be conducted in advance at a lower component level to prepare for assembly of the later production element.

In the production information managing method according to the present invention, the control center may preferably select the nearest assembly factory to the primary order-receiver as the predetermined assembly factory when information of higher accuracy on the total production amount, the final delivery date and the primary order-receiver to which the product element is shipped is obtained.

The assembly factory assembling the precedingly produced component is selected considering work cost and production capacity. However, when there is no significant difference with respect to the factors, transportation efficiency can be enhanced considering distance as in the above. Incidentally, the distance may refer to a distance in view of transport time as well as geographical and interval sense.

In the production information managing method according to the present invention, the control center may preferably display the primary prediction information and the final prediction information on a web page in accordance with an access of the orderer, the primary order-receiver and the secondary order-receiver.

By supplying the primary prediction information and the final prediction information using generally-used web page display, the information-sharing can be efficiently achieved.

In the production information managing method according to the present invention, the control center may preferably store and manage total information on the production of the product and identify an accessed party in response to the access of the orderer, the primary order-receiver and the secondary order-receiver to display a production progress information within a predetermined range to the respective accessed party.

According to the above arrangement, information management can be efficiently conducted by concentrating management of the total information on the production of the products, while sufficiently considering security by restricting access for obtaining information.

A production information managing method of apparel goods, bag and shoes according to another aspect of the present invention includes the steps of: communicatably connecting an apparel maker, a vendor, a component factory of accessory of the apparel goods, bag, and shoes, an assembly factory thereof and a control center for managing production information of the apparel goods, bag and shoes through a network; the control center obtaining information on a total production amount and final delivery date of the apparel goods, bag and shoes to be produced by the apparel maker, displaying a primary prediction information including the information on the total production amount and the final delivery date, and commanding a preceding production of a component of the accessory used for the apparel goods, bag and shoes to a predetermined component factory; when the control center obtains information on another information on a total production amount and final delivery date with higher accuracy and information on the vendor, the control center displaying final prediction information including the information on the total production amount, the final delivery date and the vendor on the web page and designating at least one assembly factory near the vendor to command transport of the precedingly produced product and assembling the accessory to the component factory and the assembly factory while transmitting information on the accessory and the assembly factory to the vendor to urge order of the accessory to the assembly factory; the assembly factory assembling and delivering the accessory to be in time for the vendor to require the accessory, the vendor incorporating the accessory into the apparel goods, bag and shoes to deliver to the apparel maker.

Apparel industry is one of the business field to which the production information managing method of the present invention can be most effectively applied, and the above arrangement is an example of applying the present invention to the apparel industry. According to the arrangement, the production efficiency of the products, i.e. the apparel goods, the bag and the shoes can be enhanced as a whole.

A control center according to the present invention is communicatably connected to computers respectively installed to an orderer of a product, a primary order-receiver for producing the product based on an order from the orderer, and a secondary order-receiver for producing product element constituting the product based on an order from the primary order-receiver, the control center managing production information of the product, including: an information input device for obtaining information on total production amount of the product to be produced, final delivery date and primary order-receiver to receive an order of the product; a supply-and-demand managing database for storing a primary prediction information from the total production amount information and the final delivery date information at an early stage of production, and for setting a final prediction information by obtaining another total production information and another final delivery date information with higher accuracy and information on the primary order-receiver having received the order of the product; and a supply-and-demand managing server for commanding preceding production of a predetermined component constituting the product element to a predetermined secondary order-receiver based on the primary prediction information and for formally placing an order of the product element directly or through the primary order-receiver to the secondary order-receiver having conducted the preceding production based on the final prediction information.

According to the control center of the present invention, the production information managing method of product of the present invention can be achieved, thereby improving overall production efficiency by the method as described above.

In the control center according to the present invention, the supply-and-demand managing database may preferably store and manage total information on the production of the product.

In the control center according to the present invention, the supply-and-demand managing server may preferably support to set up a plan including an action item to be taken by the primary and the secondary order-receiver to be in time for the final delivery date of the product including date thereof and conduct schedule management necessary for the primary order-receiver and the secondary order-receiver.

In the control center according to the present invention, the supply-and-demand managing server may preferably supply information on the assembly factory of the accessory used for the product and assembly completion time and notify a final order time of the accessory in time for the final delivery date to the orderer at a necessary time.

In the control center according to the present invention, a production capacity managing database for storing a production capacity and load condition of the secondary order-receiver and a production capacity managing server for managing the preceding production of the secondary order-receiver with reference to the production capacity managing database may preferably be provided.

In the control center according to the present invention, the secondary order-receiver may preferably be a component factory for producing the component and/or an assembly factory for assembling the product element from the component, and the production capacity managing server may preferably select an appropriate component factory and/or an assembly factory with reference to the primary prediction information and the final prediction information stored in the supply-and-demand managing database.

In the control center according to the present invention, a user-managing database for storing information on users including the orderer, the primary order-receiver and the secondary order-receiver, a user-managing server for conducting user certification with reference to the user-managing database when there is an access from any one of the users to output user-identifying information and an information output device for outputting production progress information of the product or the product element from the supply-and-demand managing database within a range related to the accessed user may preferably be provided.

By using the above arrangements, the corresponding function of the above-described production information managing method of one of the aspect of the present invention can be achieved, thereby improving the production efficiency as a whole by the above-described method.

A production information managing system of product according to further aspect of the present invention is characterized by having a control center according to the above aspect of the present invention.

According to the present aspect of the present invention, the corresponding function of the above-described production information managing method of one of the aspect of the present invention can be achieved by the control center having the above-described respective components, thereby improving the production efficiency as a whole by the above-described method.

A production information managing system of apparel goods, bag and shoes according to further aspect of the present invention includes: a computer installed in an apparel maker, a vendor, a component factory of accessory of the apparel goods, bag and shoes and an assembly factory thereof; and a control center for managing production information of the apparel goods, bag and shoes, the control center including a web server for supplying information on the apparel goods, bag and shoes and a production control server for managing production information of the apparel goods, bag and shoes; where the production control server obtains information on a total production amount and final delivery date of the apparel goods, bag and shoes to be produced and displays a primary prediction information including the information on the apparel goods, bag and shoes and the final delivery date on the web server, commands preceding production of the accessory used for the apparel goods, bag and shoes to a predetermined component factory, and, when the information on the total production amount, the final delivery date and the vendor with higher accuracy is obtained from the apparel maker, displays a final prediction information including the higher-accuracy information on the web server, designates at least one assembly factory near the vendor, commands transport of the precedingly produced component and assembly of the accessory to the component factory and the assembly factory, and transmits information on the accessory and the assembly factory to the vendor to urge order of the accessory to the assembly factory.

Apparel industry is one of the business field to which the production information managing method of the present invention can be most effectively applied, and the above arrangement is an example of applying the present invention to the apparel industry. According to the arrangement, the production efficiency of the products, i.e. the apparel goods, the bag and the shoes can be enhanced as a whole.

### BRIEF DESCRIPTION OF THE DRAWINGS

FIG. 1 is a block diagram showing a system arrangement according to an embodiment of the present invention;

FIG. 2 is a flowchart showing process flow of the aforesaid embodiment;

FIG. 3 is a time chart separately showing process flow of the aforesaid embodiment on each action of control center, apparel maker, vendor, component factory and assembly factory;

FIG. 4 is a flowchart showing a process flow of a production ability managing system of the aforesaid embodiment;

FIG. 5 is a flowchart showing a process flow of an order-tracking system of the aforesaid embodiment;

FIG. 6 is a flowchart showing a process flow of conventional production of apparel goods etc.; and

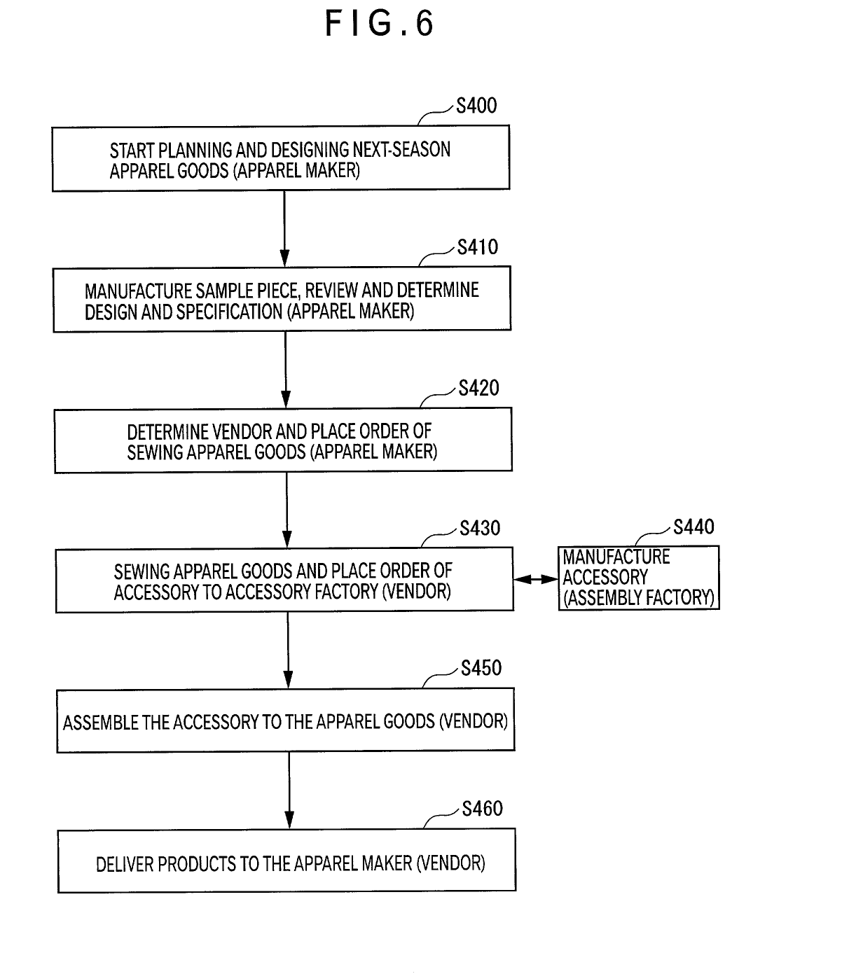

FIG. 7 is a time chart separately showing process flow of the aforesaid embodiment on each action of control center, apparel maker, vendor, component factory and assembly factory.

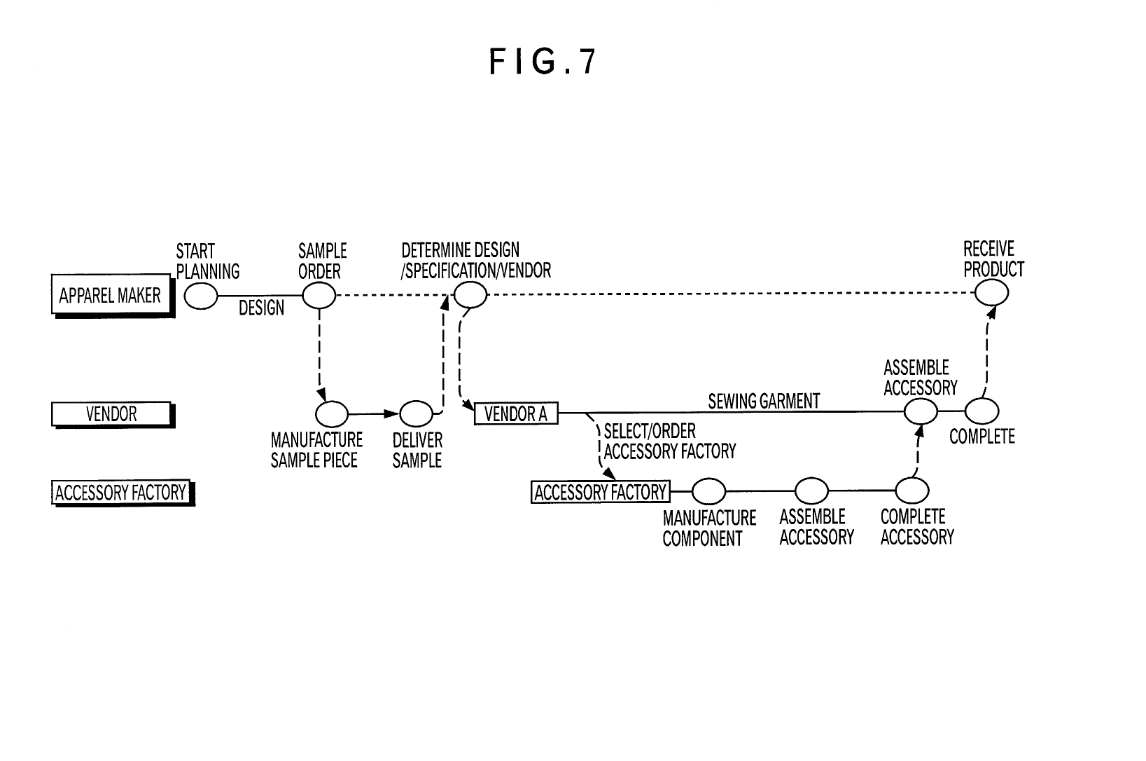

### DETAILED DESCRIPTION OF PREFERRED EMBODIMENT(S)

Next, an embodiment of “production information managing method of apparel goods, bag and shoes and production information managing system therefor” according to the present invention will be described below with reference to attached drawings.

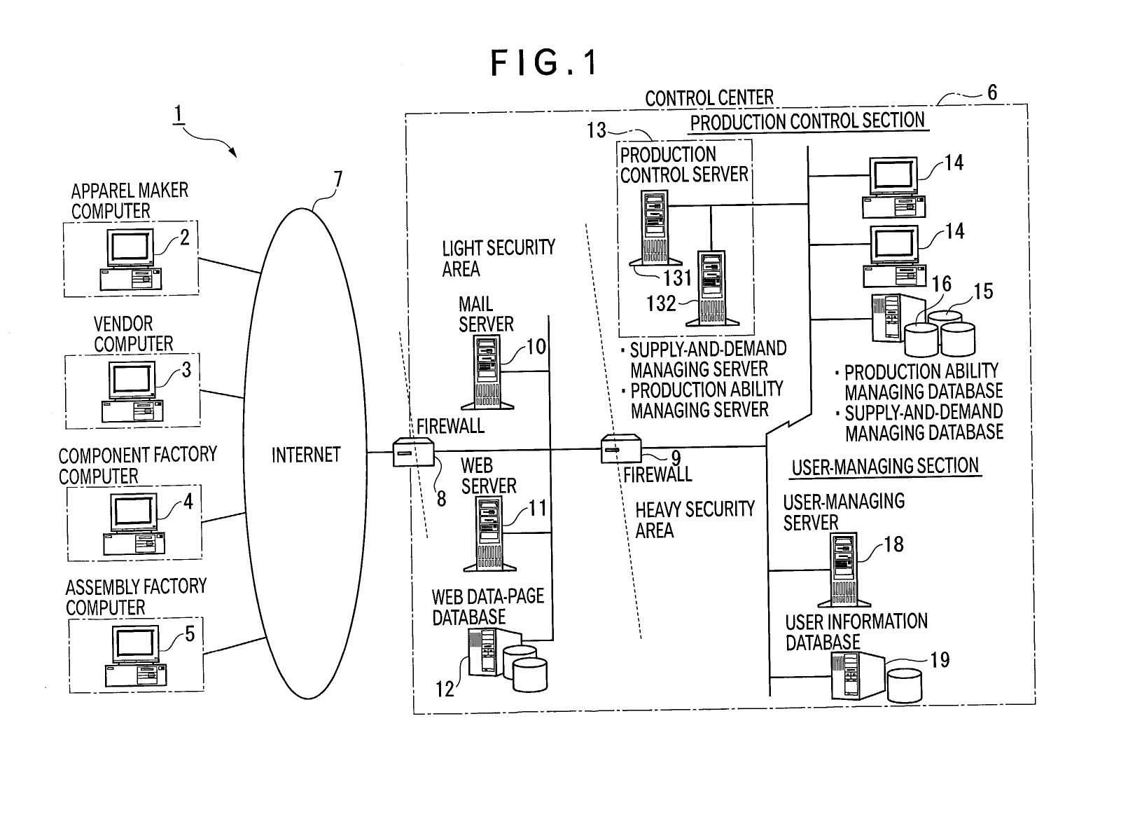

FIG. 1 shows an example of system arrangement for achieving production information management of apparel goods etc. according to the present invention.

As shown in FIG. 1, a production information managing system 1 for apparel goods etc. of the present embodiment has a computer 2 (referred to as an apparel maker computer 2 hereinafter) installed in an apparel maker, a computer 3 (referred to as a vendor computer 3 hereinafter) installed in a vendor (a dealer entrusted with production of apparel goods etc. from the apparel maker), a computer 4 (referred to as a component factory computer 4 hereinafter) installed in a component factory manufacturing components (slider and element of fastener, for instance) used for accessory of apparel goods etc., a computer 5 (referred to as assembly factory computer 5 hereinafter) installed in an assembly factory for assembling the components into accessories, and a control center 6 for managing and controlling information on production of apparel goods etc.

The control center 6 and the computers 3 to 5 installed respectively in the apparel maker, the vendor, the component factory and the assembly factory are connected through Internet 7 in a mutually communicatable manner.

The control center 6 has a light security area being divided from the outside by a firewall 8 and capable of being accessed from the outside, and a heavy security area further divided from the light security area by an additional firewall 9 and which is incapable of being accessed from the outside.

A mail server 10 for transmitting and receiving mail, a web server 11 for transmitting and receiving web pages, and a web-page database 12 (represented as web-page DB in FIG. 1) are located in the light security area.

The mail server 10, the web server 11, the web-page database 12 are connected by a common communication bus.

An information output means is constructed by the mail server 10, the web server 11, and the web-page database 12. Incidentally, the mail server 10 and the web server 11 are also used for receiving production information from the outside, which are also used as an information input means in this case.

A production control section and a user-managing section are provided in the heavy security area.

The production control section is an organization for controlling the information on the production of the apparel goods etc., thereby achieving efficient production of apparel goods etc. by efficiently utilizing information. The “organization” in the present specification collectively refers to system (including both of hardware and software) and people who operates the system.

The production control section is provided with a production control server 13, a client 14, a production ability managing database 15 and a supply-and-demand managing database 16.

Incidentally, the word “database” (15, 16) is used to represent both a collective body of systematically stored and managed data and a hardware (database server) for registering, updating and searching the data. Accordingly, as shown in FIG. 1, the production ability managing database 15 and the supply-and-demand managing database 16 may be physically stored in and managed by the same database servers, or alternatively, may be stored in separate database server. Further, the respective database servers may include other data required for operating the system.

The production control server 13 has a supply-and-demand managing server 131 and a production ability managing server 132 as main components, which supplies a production information of apparel goods etc. and commands necessary action to an interested party. Specific operation of the production control server 13 will be described below.

The client 14 is arranged as an information input means, which is a terminal for inputting and outputting information and various request to the production control server 13, thereby smoothly operating the production information managing system of the apparel goods etc.

The production ability managing database 15 is a database for storing and managing production ability and load condition of the component factory and assembly factory.

The supply-and-demand managing database 16 is a database for storing and managing information on the production activity of the vendor, the component factory and assembly factory and information on production progress of each apparel goods etc.

The production control server 13, the client 14, the production ability managing database 15 and the supply-and-demand managing database 16 are preferably connected to a common communication bus.

The user-managing section is an organization for managing the apparel maker, the vendor, the component factory and the assembly factory using the production information managing system 1 of apparel goods etc.

The user-managing section is provided with a user-managing server 18 and a user information database 19.

The user-managing server 18 is a server for certifying, registering and deleting the registration of the apparel maker, the vendor, the component factory and the assembly factory that use the system. The user information database 19 is a database for storing and managing the information on the user.

The user-managing server 18 and the user information database 19 are preferably connected to a common communication bus.

Incidentally, though the production control section and the user-managing section have separate communication buses and both of the buses are mutually communicatable in the example of FIG. 1, the production control section and the user-managing section may be connected to a common communication bus.

In the production information managing system 1 of apparel goods etc., a salesman etc. collects information on the next-season apparel goods etc. from the apparel maker and the information is inputted and stored in the supply-and-demand managing database 16 by an operator (who may be the same person as the salesman) of the production control section of the control center.

The production control server 13 sets a primary prediction information, final prediction information, a vendor information and information for order-tracking in accordance with the design and production stage to be stored to the respective databases 15 and 16, displays the information on the web server 11, and sends command of preceding production and transportation and urge request.

On the other hand, the apparel maker, the vendor, the component factory and the assembly factory can access the web server 11 through the respectively-installed computers, thereby obtaining information on the apparel goods etc. in an early stage. The user-managing section of the control center 6 conducts user-certification for those accesses and supplies appropriate information to those accessed.

Next, based on the above-described system arrangement, more specific process flow of the production information managing method will be described below.

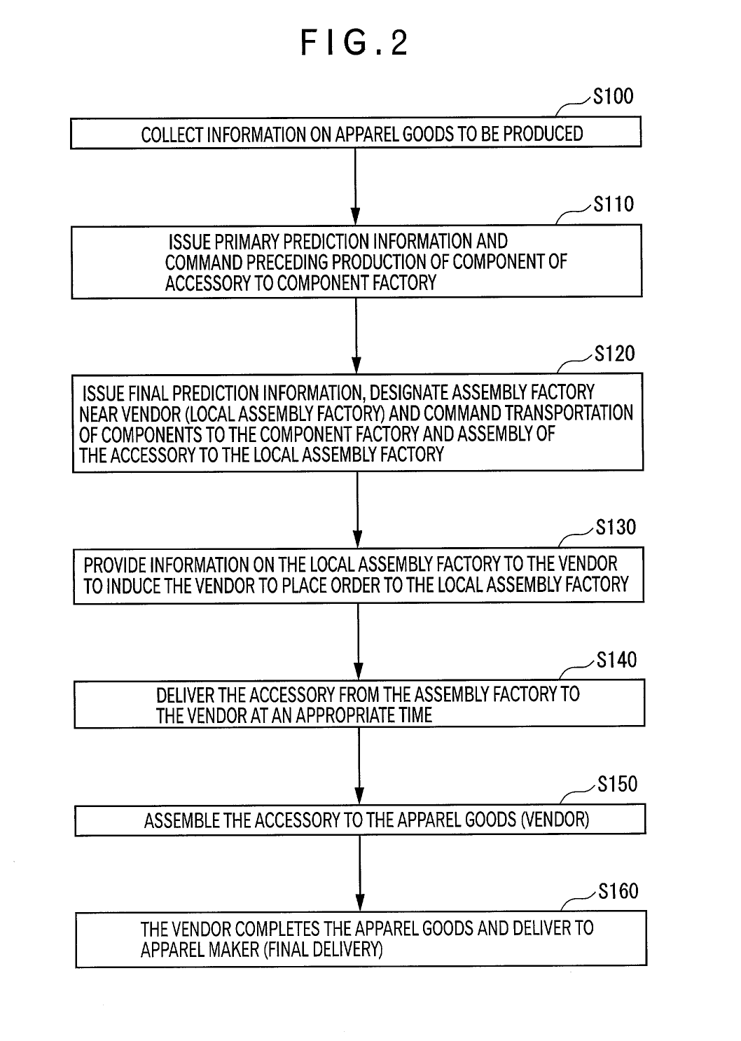

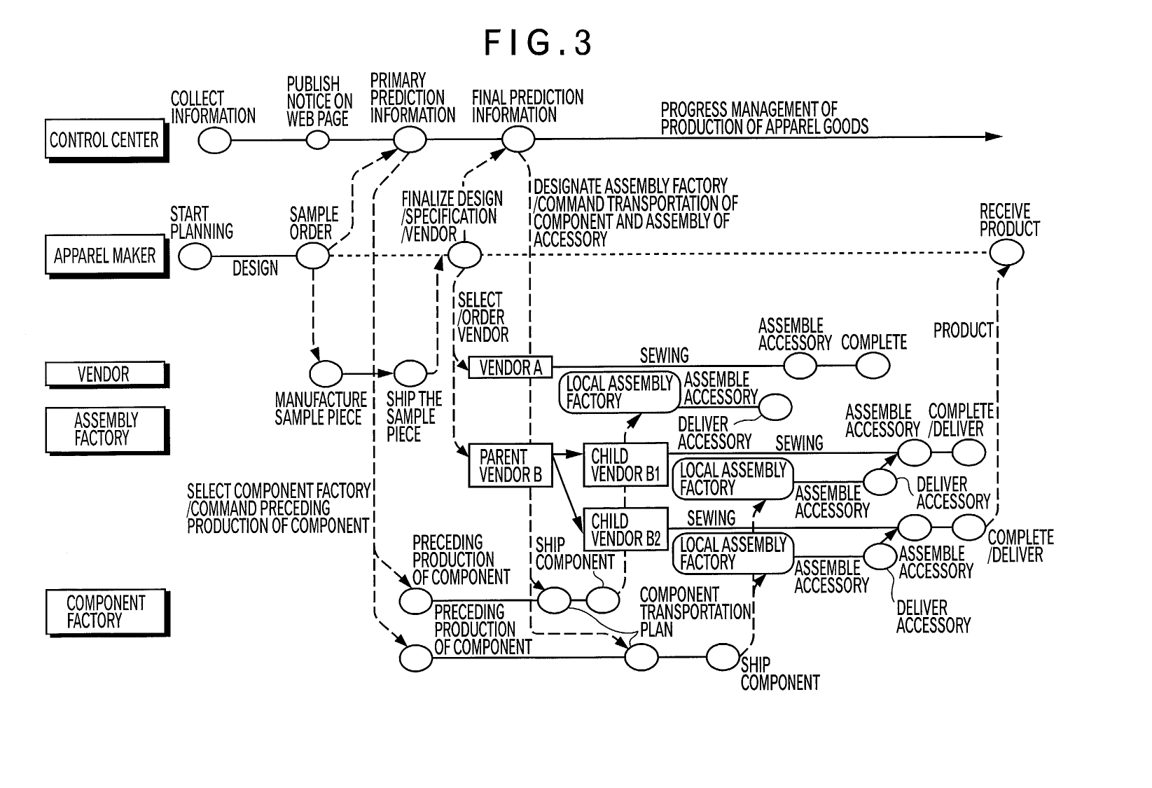

Production information managing method of apparel goods etc. according to the present invention is shown in FIG. 2. FIG. 3 shows a time chart and information flow of the control center, the apparel maker, the vendor, the assembly factory and component factory. Incidentally, the time elapses toward the right side in FIG. 3. Following description will be conducted with reference to both of the FIGS. 2 and 3.

The production information managing method of apparel goods etc. according to the present invention starts from collecting information on the apparel goods etc. to be produced in the following season (step S100 (FIG. 2)).

As described above, the product planning of the apparel maker undergoes sequential stages of getting a concept, several design trial and change, test production of a sample, determination of specification and price, and order to vendors. Accordingly, the design of the apparel goods etc. may be subject to a change until final order to the vendor. However, at the stage of sample order/sample production (see FIG. 3) to the vendor, outline of design, total product amount and final delivery date information are determined or can be predicted.

When the information on the outline design, total production amount and final delivery date of the apparel goods etc. to be produced by the apparel maker, the type, number and delivery date of the accessories used for the apparel goods etc. can be approximately known. Further, the amount, required production period etc. of producible component among the accessories without being influenced by the subsequent design change can be known, which can be produced in advance. For instance, in a case of clothes, when the outline design of the clothes themselves is completed, pull portion and dyeing specification of the fastener, and final dyeing specification of the tapes and buttons may be undetermined. However, even in this case, the slider portion and body portion of the fastener and button can be produced in advance.

Accordingly, when information on the outline total production amount and the final delivery date is obtained, the control center 6 displays a primary prediction information including such information through the web server 11 and command preceding production to the components of the accessories to the component factory capable of production (step S110 (FIG. 2), FIG. 3).

Incidentally, the preceding production may be commanded based on voluntary offer of the component factory seeing the primary prediction information, or alternatively, may be commanded by the control center 6 grasping the production ability and load of the respective component factories and selecting an appropriate component factory (production ability managing system). The latter case will be described later.

The apparel maker simultaneously checks the test-produced sample, reviews the design and specification, selects the vendor and sends final order of the apparel goods etc. to the selected vendor (see FIG. 3).

Incidentally, since the apparel maker selects a vendor that meets specific requirement for each season, unpredicted vendor may be selected or the order may often be sent to a plurality of geographically remote vendors. Further, the vendor receiving the order may place the order the other vendors (see vendor A, parent vendor B and child vendors B1, B2 in FIG. 3). Accordingly, until the order-receiving vendor is settled, the assembly factory suitable for delivering the accessories to the order-receiving vendor is difficult to be decided.

By the final order to the vendor, the information on the order-receiving vendor is settled and the design/specification, total production amount, final delivery date etc. of the apparel goods etc. (including the accessories) are settled with high accuracy according to the contents of the final order.

Accordingly, the control center 6 obtains the information on the final order to the vendor, displays a final prediction information including the design/specification, total production amount, final delivery date etc. of the apparel goods etc. (including the accessories) through the web server 11 and designates an assembly factory (local assembly factory) near the vendor, while commanding the component factory to transport the components to the local assembly factory and commanding the components to be delivered, accessories to be assembled and work plan to the local assembly factory (step S120 (FIG. 2), FIG. 3).

Incidentally, the term assembly factory being “near” the vendor is ordinarily used for indicating short distance. However, the term is not limited to such meaning but the “near” assembly factory includes a case with established transporting means even from a distance.

The local assembly factory is selected either by voluntary offer of preceding production by the assembly factory seeing the final prediction information or by command of the control center 6 grasping the production ability and load of the respective assembly factories and selecting an appropriate assembly factory to which the assembly is commanded (production ability managing system). The latter arrangement will be described later.

Next, the control center 6 informs the order-receiving vender of the respective “near” local assembly factory and a scheduled date when the accessories are to be delivered by the local assembly factory (step S130 (FIG. 2)).

Since the component is produced in advance at an early stage, the accessories delivered by the local assembly factory are completed much earlier stage as compared to production after the design/specification of the apparel goods etc. is finalized. Accordingly, in order to meet the early delivery date of the apparel goods etc. set by the apparel maker, it is beneficial for the order-receiving vendor to purchase the accessories from the local assembly factory. Accordingly, information on the local assembly factory and the delivery schedule to the order-receiving vendor enhances order of the accessories to the local assembly factory, thereby greatly reducing production period of the apparel goods etc.

When the accessories are ordered to the local assembly factory, the local assembly factory assembles and delivers the accessories at the time for the order-receiving vendor to require the accessories in accordance with the contract with the order-receiving vendor or the information from the control center 6 (step S140 (FIG. 2), FIG. 3).

The order-receiving vendor having received the accessories from the local assembly factory assembles the accessories to the apparel goods etc. (step S150 (FIG. 2)) and delivers the completed apparel goods etc. to the apparel maker (step S160 (FIG. 2), FIG. 3).

As will be clear from the above description, according to the production information managing method of the apparel goods etc. of the present invention and the production information managing system for achieving the method, the components of the accessories whose specification etc. is substantially settled are produced prior to finalizing the design and specification at the planning stage of the apparel goods etc. and, when the order-receiving vendor is settled, the components are distributed and transported to the adjacent local assembly factory.

Accordingly, the components of the accessories are completed when the order-receiving vendor receives the order and are assembled as the accessories at the local assembly factory, so that the order-receiving vendor can obtain the accessories at an early stage. Accordingly, the production time of the order-receiving vendor can be greatly reduced as compared to the conventional arrangement where the accessories are ordered to the accessory factory after the vendor receives the order and the apparel goods are completed by assembling the accessories after completion of the accessories. Further, the production time of the apparel goods etc. can be greatly reduced as a whole.

Incidentally, the “component factory” and the “assembly factory” are described as of different locations and businesses in the above, in the specific case, the component factory and the assembly factory may be the same entity or different department of the same business entity, or further alternatively, may be business entities of cooperative relationship. The “factory” not only represents physical production facilities but also refers to business entity and producer.

Next, a “production ability managing system” and “order-tracking system for assisting the production information managing method of the apparel goods etc. will be described below. First, outline of the production ability managing system will be described.

The production ability managing system is a system where the control center 6 constantly grasps the production ability and load condition of the component factory and assembly factory and selects the appropriate component factory and assembly factory based on the primary prediction information and the final prediction information to command preceding production of the components and assembly of the accessories.

The production managing system is materialized by a program installed in the production ability managing database 15 and the production ability managing server 132 of the production control section for conducting the following process.

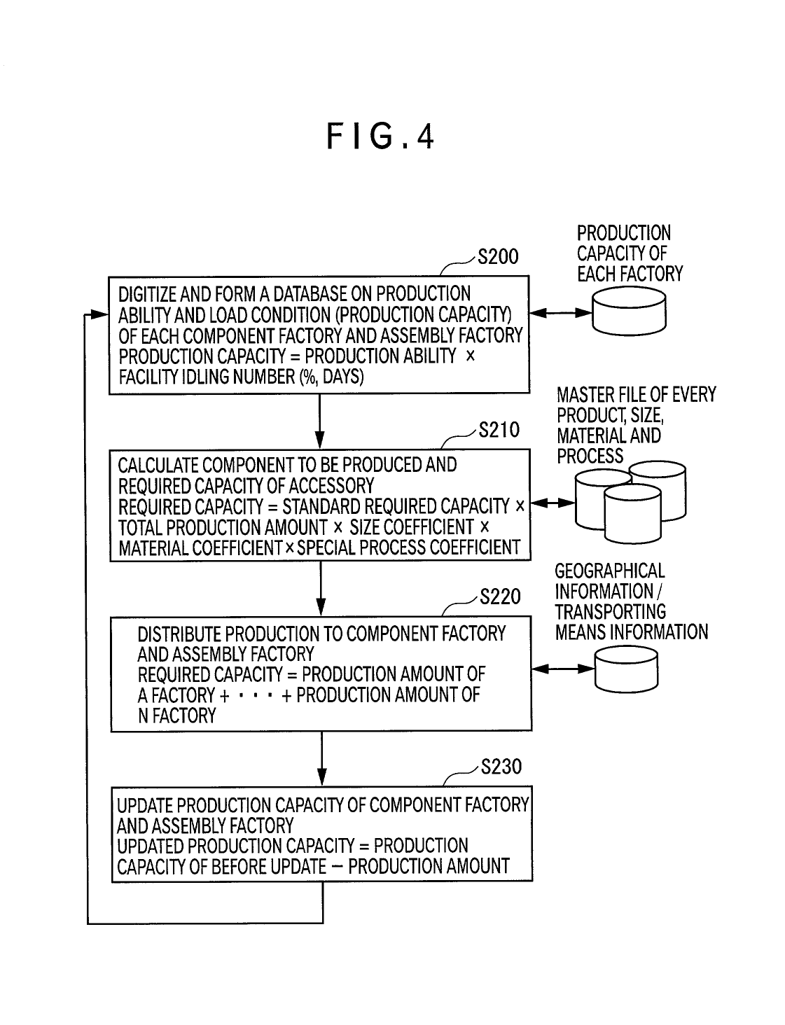

FIG. 4 shows a process flow of the production ability managing system.

In order to grasp the production ability and load condition of the component factory and assembly factory, the production ability managing system evaluates the production ability and load condition of each of the component factory and the assembly factory as an objective value (production capacity) to form a database as a preliminary process (step S200).

The production capacity can be represented as a product of production capacity (production capacity amount) when the factory is in full operation and remaining power of the factory (facility idling number (represented as percentage or days)).

Production Capacity=(Production Capacity Amount) * (Facility Idling Number)

(represented as % or days)

The production capacity is calculated for each of the component factory and assembly factory to form a database.

When the total production amount and the final delivery date of the components and the accessories to be produced are shown by the primary prediction information or the final prediction information, the production ability managing system calculates a required capacity of the components and the accessories to be produced (step S210).

Required Capacity=(Standard Required Capacity) * (Total Production Amount) * (Size Coefficient) * (Material Coefficient) * (Special Process Coefficient)

The standard required capacity is a value representing facilities and time necessary for producing one component/accessory of standard specification, the size coefficient is a dissociation coefficient of the standard required capacity when the size is separated from a standard size, the material coefficient is a dissociation coefficient of the standard required capacity when the material of the component/accessory is different from a standard material, and the special process coefficient is a dissociation coefficient of the standard required capacity when a special process is conducted. The required capacity is a product of the standard required capacity, the total production amount, the size coefficient, the material coefficient and the special process coefficient, i.e. a value representing facilities and time required for producing the entirety of the components and accessories to be produced. The required capacity is a value of the same dimension as the production capacity of the factories, which is equivalent to the production capacity.

The data of the standard required capacity, the size coefficient, the material coefficient and the special process coefficient is stored and managed as master files of each product, size, material and process, which is referred in calculating the required capacity.

Next, the production capacity managing system production-distributes the required capacity to the respective component factories and the assembly factories (step S220).

Required Capacity=(A factory production amount)+ . . . +(N factory production amount)

The production amount of the respective factory is distributed to be within the range of the production capacity of the respective factories. Accordingly, production concentration on a single factory can be prevented. Further, considering the delivery date of the products, when the delivery time is short, the production can be distributed to a plurality of the component factories and the assembly factories.

When the assembly of the accessories is distributed by selecting the assembly factory, geographical information and transport means of the assembly factory (transport cost from the component factory to the assembly factory) may preferably be displayed to support decision of production distribution to the assembly factory. In this case, some candidates for the local assembly factory are searched based on the condition of the distance and transport means when the vendor is designated, and the production capacity of the assembly factory is displayed on the screen. Accordingly, the operator can easily distribute the production of the component and accessories to the candidate assembly factories.

After completing production distribution to the component factory and the assembly factory, the production capacity of the component factory and the assembly factory distributed with the production is updated (step S230) and the process returns to step S200. In the factory distributed with production, the operation of the facilities is increased and the capacity for accepting order of production (production capacity) is decreased.

Updated Production Ability=Production Ability before Update−Production Amount

According to the above-described production capacity managing system, the production capacity (ability to produce) of the respective component factories and the assembly factories is constantly grasped by the production control section, so that the production of the components and the accessories can be distributed to the respective factories in a reasonable manner in accordance with delivery time thereof, thereby preventing production concentration to the specific factories and responding short delivery time of apparel goods etc.

Next, order-tracking system will be described below.

The order-tracking system is a system where, when the apparel maker orders the apparel goods etc., plan setting of the actions to be taken by the vendors, the component factories and the assembly factories is supported and schedule therefor is controlled in accordance with the final delivery date. The order-tracking system is materialized by a program installed in the supply-and-demand managing database 16 and the supply-and-demand managing server 131 for conducting following process.

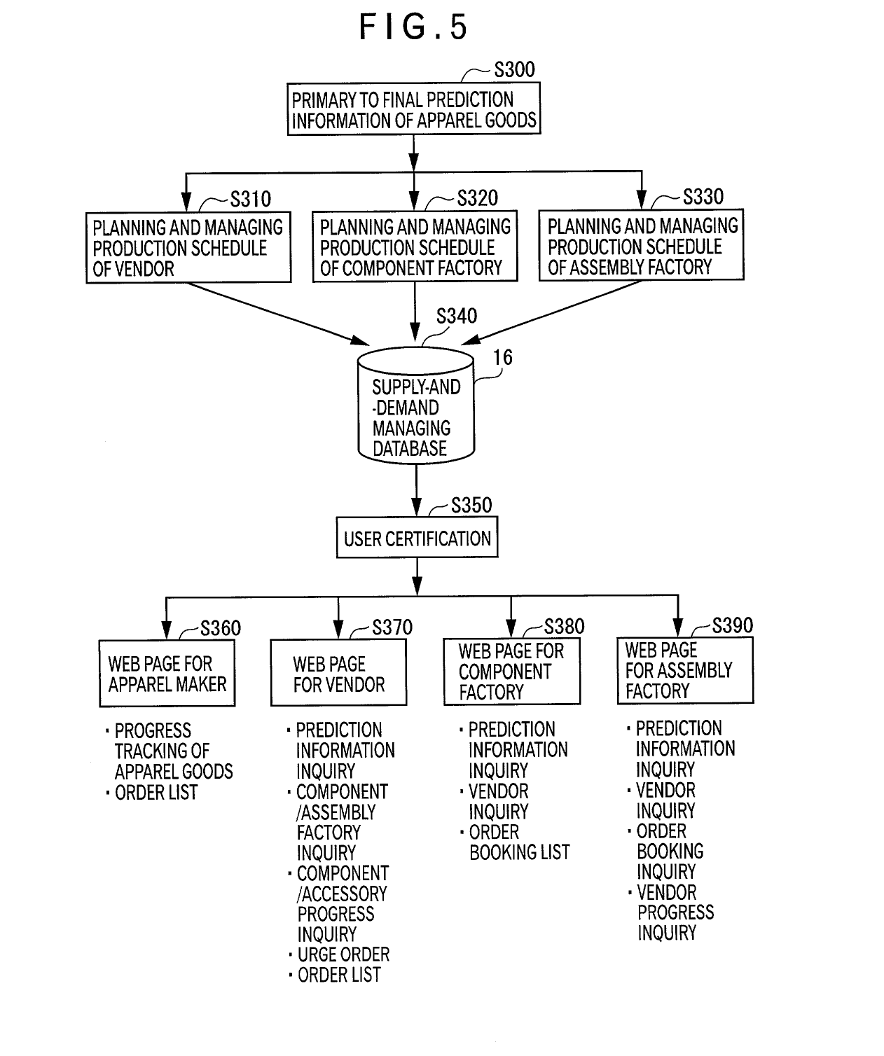

FIG. 5 shows a process flow of the order-tracking system.

When the primary prediction information to the final prediction information of the apparel goods etc. are issued, the order-tracking system supports to set up a plan of the actions to be taken by the related vendors, the component factories and the assembly factories and the production schedule including the date of the actions (steps S300 to S330).

For instance, when the primary prediction information is issued, since the component factory for producing the components in advance has to decide the shipping date of the components, the order-tracking system displays shipping date of the components on the production schedule of the component factory, which is decided by the operator. In this case, the plan-setting of the schedule may be further facilitated by highlighting a critical path occurring on the entire schedule by deciding the shipping date.

When the final prediction information is issued, the vendor is settled and the local assembly factory is selected. By settling the local assembly factory, the component factory has to conduct order-booking of the transportation of the components. Accordingly, the order-tracking system displays an order-booking field on the production schedule of the component factory for transporting the component, which is incorporated in the production schedule of the component factory.

The final order-date for the vendor to order the accessories is decided by the delivery date of the apparel goods etc. Accordingly, the order-tracking system displays a final order date field of the accessories on the production schedule of the vendor, which is incorporated in the production schedule of the vendor.

With regard to the assembly factory, since the delivery date of the components is decided by the production schedule of the component factory and the date for assembling the accessories and delivering to the vendor is approximately settled by the production schedule of the vendor, the order-tracking system incorporates the shipment of the components and accessories to the production schedule of the assembly factory.

After the production schedule of the vendor, the component factory and the assembly factory is planned, all the information is stored in the supply-and-demand managing database 16 (step S340). The order-tracking system has a calendar, whereby monitoring the production schedule of the vendor, the component factory and the assembly factory to urge the related party as necessary (schedule management).

On the other hand, the order-tracking system supplies information on the production of the apparel goods etc. to the related party.

In other words, when the apparel maker, or the vendor, or the component factory or the assembly factory accesses the web server 11, the user-managing server 18 and the user information database 19 conduct user certification.

During the user certification, whether the accessed one is a legitimate user capable of using the production information managing system 1 or not is checked, the accessed party is identified and user-identifying information is obtained (step S350).

The user-managing server 18 transmits the user-identifying information of the accessed party to the production control server 13, and the order-tracking system displays the web page on the information related to the accessed party on the web server 11 (steps S360-390). Incidentally, known method may be used in order to display the information related only to the accessed party, where, for instance, a field for accessible party is added to the data which is verified with the user-identifying information of the accessed party.

When the apparel maker accesses, order list of the apparel maker, and progress information of the apparel goods etc. of the apparel maker are displayed (step S360).

When the vendor accesses, primary to final prediction information, reference of the component/assembly factory, reference of progress information of the component/accessories related to the vendor, order list of the vendor etc. are displayed and final order of the accessories is urged (step S370).

When the component factory accesses, primary to final prediction information, reference of the vendor, progress information of the order-booking etc. are displayed (step S380).

When the assembly factory accesses, primary to final prediction information, reference of the vendor, progress information of the order-booking, progress information on the apparel goods etc. of the vendor etc. are displayed (step S390).

According to the above order-tracking system, when the primary to final prediction information of the apparel goods etc. is issued, the respective production schedule of the vendor, the component factory and the assembly factory can be planned, thereby achieving systematically planned production of the apparel goods etc. as a whole.

With regard to information supply, the apparel maker, the vendor, the component factory and the assembly factory can mutually see the progress of the production activity. Accordingly, mutual production activity can be connected in an organized manner, thereby preventing delay in production activity and enabling to take countermeasures at an early stage when the production is delayed.

Incidentally, while the information on the production activity of all of the related party is concentrated on the supply-and-demand database 16 in order to consistently manage information of the production of the apparel goods etc. by the order-tracking system, the accessed party is identified in supplying the information to show only the information related to the accessed party. Accordingly, concentration of the information and security of the information can be simultaneously achieved.

Incidentally, the scope of the present invention is not restricted to the above embodiments, but includes following modifications etc.

For instance, the distinction of the secondary order-receivers, i.e. the assembly factory and the component factory, and the distinction of the component and the product element (accessories) are only relative concept. Irrespective of the existing distinction concept, those capable of preceding production may be referred to as the “component” and the factory producing the component may be referred to as the component factory.

The assembly factory and the component factory may be within the same location and the same corporation, or alternatively, may be of remote locations or of different corporations. When only the assembly factory is the secondary order-receiver, the present invention can be applied if specific components can be produced in advance within the factory. On the other hand, the present invention can be applied when only the component factory is the secondary order-receiver and the component is delivered to the primary order-receiver without requiring assembly.

In the present invention, the information input means is not restricted to the client 14 manually operated and inputted by a salesperson but a system receiving information through electric mail or an information system automatically collecting necessary information checking the web site etc. of the orderer may be used.

In the present invention, the information output means may be, as well as the web server 11 and the mail server 10, other information communication system such as cable television or, alternatively, delivered paper-output of the information.

The function of the respective servers and the database can be respectively achieved by a program executed on the computer. Such program can be installed in the computer using existing various magnetic and optical recording medium and communication-transmitting medium.

The present invention is not solely applied to the apparel business field, but may also be applied to architectural field and building material field.

For instance, in both of the large building and personal housing, the orderer corresponds to client (either large developers or individuals), the primary order-receiver corresponds to constructor, and the second order-receiver corresponds to dealer of building-material. The product corresponds to the building or a house, the product element corresponds to building material (door or sash), and the component corresponds to a door-closer, door key, sash frame and lock mechanism.

It takes considerable time from outline design of a building to finalization of the minute design. However, for instance, when the window position etc. is substantially determined, necessary sash frame etc. can be produced to some degree in advance, thereby obtaining advantages by applying the present invention as in the apparel goods etc.

What is claimed is:

1. A production information managing method, comprising the step of:
comminicatably connecting an orderer of a product, a primary order-receiver producing the product based on an order from the orderer, a secondary order-receiver producing a product element constituting the product based on a order from the primary orderer, and a control center for managing a production information of the product through a network,
wherein the control center sets a primary prediction information by obtaining a total production amount information and a final delivery date information of the product to be produced from the orderer, commands a preceding production of a predetermined component constituting the product element to a predetermined secondary order-receiver based on the primary prediction information, sets a final prediction information by obtaining from the orderer another total production amount information and another final delivery date information with higher accuracy than the primary prediction information and information on the primary order-receiver having received the order of the product, and formally orders the product element through the primary order-receiver or directly to the secondary order-receiver having conducted the preceding production.

2. The production information managing method according to claim 1, wherein the control center selects the predetermined secondary order-receiver with reference to pre-stored data of a production capacity and a load condition of the secondary order-receiver, and commands the preceding production and production of the product element to the secondary order-receiver so as to be in time for the final delivery date of the product.

3. The production information managing method according to claim 1, wherein the control center supports to set up a plan including action item to be taken by the primary order-receiver and the secondary order-receiver and specific date thereof so as to be in time for the final delivery date of the product, and manages a schedule necessary for the primary order-receiver and the secondary order-receiver.

4. The production information managing method according to claim 3, wherein the control center supplies information on the predetermined secondary order-receiver producing the product element used for the product and information on production completion time of the product element and notifies a final order time of the product element capable of being in time for the final delivery date of the product.

5. The production information managing method according to claim 3, wherein the control center commands the primary order-receiver to order the product element to the secondary order-receiver having conducted the preceding production based on the final prediction information, and commands the secondary order-receiver to produce the product element from the precedingly produced components in order to deliver the product element in time for the time required for the primary order-receiver.

6. The production information managing method according to claim 1, wherein the secondary order-receiver is a component factory for producing the component and/or an assembly factory for assembling the product element from the component, and
wherein the control center commands preceding production of the predetermined component to the predetermined component factory and/or the assembly factory when the primary prediction information is set, commands assembly of the precedingly produced component into the product element to the component factory and/or the assembly factory when the final prediction information is set and transmits information on the product element and the predetermined component factory and/or the assembly factory to the primary order-receiver to command to place an order of the product element to the predetermined component factory and/or the assembly factory.

7. The production information managing method according to claim 1, wherein the secondary order-receiver is a component factory for producing the component and an assembly factory for assembling the product element from the component, and
wherein the control center commands preceding production of the predetermined component to the predetermined component factory when the primary prediction information is set, commands to the component factory to transport the precedingly produced component to the predetermined assembly factory and commands to the assembly factory to assemble the precedingly produced component into the product element when the final prediction information is set, and transmits information on the product element and the predetermined assembly factory to the primary order-receiver to command to place an order of the product element to the predetermined assembly factory.

8. The production information managing method according to claim 7, wherein the control center selects the nearest assembly factory to the primary order-receiver as the predetermined assembly factory when information of higher accuracy on the total production amount, the final delivery date and the primary order-receiver to which the product element is shipped is obtained.

9. The production information managing method according to claim 1, wherein the control center displays the primary prediction information and the final prediction information on a web page in accordance with an access of the orderer, the primary order-receiver and the secondary order-receiver.

10. The production information managing method according to claim 9, wherein the control center stores and manages total information on the production of the product and identifies an accessed party in response to the access of the orderer, the primary order-receiver and the secondary order-receiver to display a production progress information within a predetermined range to the respective accessed party.

11. A production information managing method of apparel goods, bag and shoes, comprising the steps of:
communicatably connecting an apparel maker, a vendor, a component factory of accessory of the apparel goods, bag, and shoes, an assembly factory thereof and a control center for managing production information of the apparel goods, bag and shoes through a network;
the control center obtaining information on a total production amount and final delivery date of the apparel goods, bag and shoes to be produced by the apparel maker, displaying a primary prediction information including the information on the total production amount and the final delivery date, and commanding a preceding production of a component of the accessory used for the apparel goods, bag and shoes to a predetermined component factory;
when the control center obtains information on another information on a total production amount and final delivery date with higher accuracy and information on the vendor, the control center displaying final prediction information including the information on the total production amount, the final delivery date and the vendor on the web page and designating at least one assembly factory near the vendor to command transport of the precedingly produced product and assembling the accessory to the component factory and the assembly factory while transmitting information on the accessory and the assembly factory to the vendor to urge order of the accessory to the assembly factory;
the assembly factory assembling and delivering the accessory to be in time for the vendor to require the accessory, the vendor incorporating the accessory into the apparel goods, bag and shoes to deliver to the apparel maker.

12. A control center being communicatably connected to computers respectively installed to an orderer of a product, a primary order-receiver for producing the product based on an order from the orderer, and a secondary order-receiver for producing product element constituting the product based on an order from the primary order-receiver, the control center managing production information of the product, comprising:
an information input device for obtaining information on total production amount of the product to be produced, final delivery date and primary order-receiver to receive an order of the product;
a supply-and-demand managing database for storing a primary prediction information from the total production amount information and the final delivery date information at an early stage of production, and for setting a final prediction information by obtaining another total production information and another final delivery date information with higher accuracy and information on the primary order-receiver having received the order of the product; and
a supply-and-demand managing server for commanding preceding production of a predetermined component constituting the product element to a predetermined secondary order-receiver based on the primary prediction information and for formally placing an order of the product element directly or through the primary order-receiver to the secondary order-receiver having conducted the preceding production based on the final prediction information.

13. The control center according to claim 12, wherein the supply-and-demand managing database stores and manages total information on the production of the product.

14. The control center according to claim 12, wherein the supply-and-demand managing server supports to set up a plan including an action item to be taken by the primary and the secondary order-receiver to be in time for the final delivery date of the product including date thereof and conducts schedule management necessary for the primary order-receiver and the secondary order-receiver.

15. The control center according to claim 14, wherein the supply-and-demand managing server supplies information on the assembly factory of the accessory used for the product and assembly completion time and notifies a final order time of the accessory in time for the final delivery date to the orderer at a necessary time.

16. The control center according to claim 12, further comprising a production capacity managing database for storing a production capacity and load condition of the secondary order-receiver and a production capacity managing server for managing the preceding production of the secondary order-receiver with reference to the production capacity managing database.

17. The control center according to claim 16, wherein the secondary order-receiver is a component factory for producing the component and/or an assembly factory for assembling the product element from the component, and
wherein the production capacity managing server selects an appropriate component factory and/or an assembly factory with reference to the primary prediction information and the final prediction information stored in the supply-and-demand managing database.

18. The control center according to claim 12, further comprising: a user-managing database for storing information on users including the orderer, the primary order-receiver and the secondary order-receiver; a user-managing server for conducting user certification with reference to the user-managing database when there is an access from any one of the users to output user-identifying information; and an information output device for outputting production progress information of the product or the product element from the supply-and-demand managing database within a range related to the accessed user.

19. A production information managing system of product having a control center according to any one of claims 12 to 18.

20. A production information managing system of apparel goods, bag and shoes, comprising:
a computer installed in an apparel maker, a vendor, a component factory of accessory of the apparel goods, bag and shoes and an assembly factory thereof; and
a control center for managing production information of the apparel goods, bag and shoes, the control center including a web server for supplying information on the apparel goods, bag and shoes and a production control server for managing production information of the apparel goods, bag and shoes;
wherein the production control server obtains information on a total production amount and final delivery date of the apparel goods, bag and shoes to be produced and displays a primary prediction information including the information on the apparel goods, bag and shoes and the final delivery date on the web server, commands preceding production of the accessory used for the apparel goods, bag and shoes to a predetermined component factory, and, when the information on the total production amount, the final delivery date and the vendor with higher accuracy is obtained from the apparel maker, displays a final prediction information including the higher-accuracy information on the web server, designates at least one assembly factory near the vendor, commands transport of the precedingly produced component and assembly of the accessory to the component factory and the assembly factory, and transmits information on the accessory and the assembly factory to the vendor to urge order of the accessory to the assembly factory.
